(19) United States
(12) Patent Application Publication
(10) Pub. No.: US 2023/0406264 A1
(43) Pub. Date: Dec. 21, 2023

(54) VEHICLE, CONTROL METHOD FOR VEHICLE, AND COMPUTER-READABLE STORAGE MEDIUM

(71) Applicant: TOYOTA JIDOSHA KABUSHIKI KAISHA, Toyota-shi (JP)

(72) Inventors: Katsuharu TACHIBANA, Nagoya-shi (JP); Nana KIKUIRE, Sunto-gun (JP); Hiroshi INOUE, Nagoya-shi (JP)

(21) Appl. No.: 18/337,530

(22) Filed: Jun. 20, 2023

(30) Foreign Application Priority Data
Jun. 21, 2022 (JP) 2022-099703

(51) Int. Cl. B60R 25/24; G06K 7/10; B60Q 3/20; B60Q 3/70; B60Q 9/00

(52) U.S. Cl. CPC B60R 25/24; G06K 7/10297; B60Q 3/20; B60R 25/01; B60Q 9/00; B60R 2325/103; B60Q 3/70

(57) ABSTRACT

There is provided a vehicle having: an acquiring section acquiring a notification that permission for usage as a key of the vehicle has been granted from an information processing device to an information processing device; and a control section that, in accordance with acquisition of the notification, controls a presentation for urging the information processing device to communicate via an NFC (Near Field Communication) reader provided at the vehicle, in order to have the information processing device start usage as the key.

### CROSS-REFERENCE TO RELATED APPLICATION

This application is based on and claims priority under 35 USC 119 from Japanese Patent Application No. 2022-099703 filed on Jun. 21, 2022, the disclosure of which is incorporated by reference herein.

### TECHNICAL FIELD

The present disclosure relates to a vehicle, a control method for a vehicle, and a computer-readable storage medium that stores a control program for a vehicle.

### RELATED ART

The use of automobiles as elements of transportation services is becoming popular, and it is anticipated that car sharing and other various services will increase and become even more widespread. Accompanying this trend, there is an increasing need for wireless digital key systems that make the transfer of physical keys unnecessary by using smartphones as keys of the automobiles.

Patent Document 1 is an example of a technique relating to a wireless digital key system. Japanese Patent Application Laid-Open (JP-A) No. 2020-33707 (Patent Document 1) discloses an electronic key system for a vehicle that is provided with a portable device and an onboard device, and that carries out unlocking of the door locks of a vehicle and the like by establishing authentication of the portable device by the onboard device.

### SUMMARY

The CCC (Car Connectivity Consortium) has formulated standards relating to vehicle electronic key systems. Owner devices, which are devices used by owners of vehicles, and friend devices, which are devices supposing usage by friends or family of the owner, are prescribed in the standards formulated by the CCC.

At the time of adding a friend device, communication is carried out between the friend device and the vehicle, and information relating to the digital key must be shared between the friend device and the vehicle. If communication cannot be carried out between the friend device and the vehicle, the friend device cannot function as a key of the vehicle.

The present disclosure was made in view of the above-described point, and an object thereof is to provide a vehicle, a control method for a vehicle, and a control program for a vehicle, which can urge a friend device to carry out communication with a vehicle.

One aspect of the present invention is a vehicle including: an acquiring section acquiring a notification that permission for usage as a key of the vehicle has been granted from a first information processing device to a second information processing device; and a control section that, in accordance with acquisition of the notification, controls a presentation for urging the second information processing device to communicate via an NFC (Near Field Communication) reader provided at the vehicle, in order to have the second information processing device start usage as the key.

In accordance with this one aspect of the present invention, by carrying out a presentation for urging communication via the NFC reader provided at the vehicle, communication between the vehicle and the second information processing device, which is to become a friend device, can be encouraged.

In accordance with the present disclosure, there can be provided a vehicle, a control method for a vehicle, and a computer-readable storage medium that stores a control program for a vehicle, which, by carrying out a presentation for urging communication via an NFC reader provided in a vehicle, can urge a second information processing device that is to become a friend device to carry out communication with the vehicle.

### BRIEF DESCRIPTION OF THE DRAWINGS

FIG. 1 is a drawing illustrating the schematic structure of a digital key system of a vehicle relating to a present embodiment.

FIG. 2 is a drawing illustrating an example of hardware structures of the vehicle.

FIG. 3 is a block drawing illustrating an example of functional structures of the vehicle.

FIG. 4 is a flowchart illustrating the flow of processings by the digital key system of the vehicle.

### DETAILED DESCRIPTION

An example of an embodiment of the present disclosure is described hereinafter with reference to the drawings. Note that, in the drawings, the same reference numerals are given to structural elements and portions that are the same or equivalent. Further, the dimensional proportions in the drawings are exaggerated for convenience of explanation, and there are cases in which they differ from actual proportions.

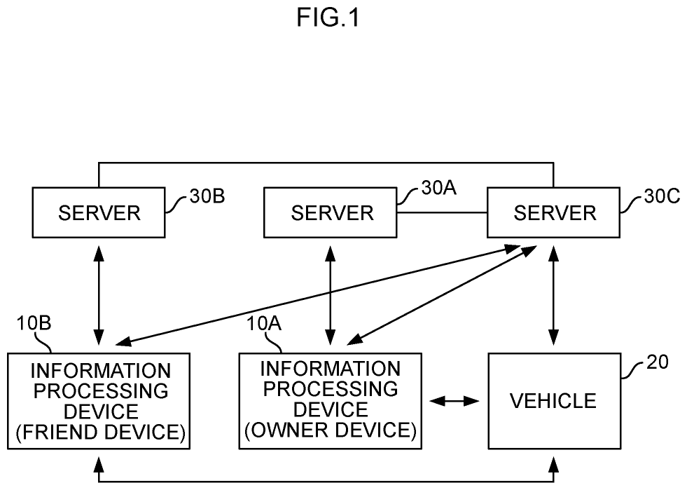

FIG. 1 is a drawing illustrating the schematic structure of a digital key system of a vehicle relating to the present embodiment.

The digital key system illustrated in FIG. 1 includes information processing devices 10A, 10B, a vehicle 20, and servers 30A, 30B, 30C.

The information processing device 10A is a device in which is stored a key (a digital key) for unlocking the locks of the vehicle 20 and making driving of the vehicle 20 possible, and can be a portable device such as, for example, a smartphone, a wearable device, or the like. The information processing device 10A communicates with the vehicle 20 by using near wireless communication technology such as BLE (Bluetooth® Low Energy), NFC (Near Field Communication), UWB (Ultra Wide Band), or the like. The information processing device 10A can be an owner device in the “Digital Key” standards formulated by the CCC. The information processing device 10A is an example of the first information processing device of the present disclosure.

In the same way as the information processing device 10A, the information processing device 10B as well is a device in which is stored a key (a digital key) for unlocking the locks of the vehicle 20 and making driving of the vehicle 20 possible, and can be a portable device such as, for example, a smartphone, a wearable device, or the like. The information processing device 10B communicates with the vehicle 20 by using near wireless communication technology such as BLE, NFC, UWB, or the like. The information processing device 10B can be a friend device in the “Digital Key” standards formulated by the CCC. The information processing device 10B is an example of the second information processing device of the present disclosure.

The information processing devices 10A, 10B can be used as a digital key of the vehicle 20 by, for example, downloading and installing an application for causing that device to function as a digital key of the vehicle 20, and sharing information relating to the digital key with the vehicle 20.

The vehicle 20 carries out near wireless communication by any of the above-described, various near wireless communication techniques with the information processing device 10A, 10B that functions as a digital key of the vehicle 20, and executes processings relating to a digital key. The vehicle 20 executes locking processing and unlocking processing of the doors of the vehicle 20 as processings relating to a digital key. Further, the vehicle 20 executes the processing of starting-up the engine or the motor on the basis of an engine or motor start-up request from the information processing device 10A, 10B that operates as a digital key of the vehicle 20.

Note that, when the vehicle 20 receives an engine start-up request from the information processing device 10A, 10B, the vehicle 20 judges whether or not the information processing device 10A, 10B exists within the cabin of the vehicle 20. The reason for judging whether or not the information processing device 10A, 10B exists within the cabin of the vehicle 20 is in order to prevent starting of the engine in a state in which the information processing device 10A, 10B is outside of the vehicle cabin. The vehicle 20 judges whether or not the information processing device 10A, 10B exists within the cabin of the vehicle 20 by referring to the strength of the radio waves that are emitted from the information processing device 10A, 10B and are received by an antenna provided within the vehicle cabin.

Further, in a case in which the information processing device 10B is to be added as a friend device, the information processing device carries out communication with an antenna provided at a predetermined place within the cabin of the vehicle 20, and shares information relating to the digital key with the vehicle 20.

The server 30A is a server for providing, to the information processing device 10A, information for having the information processing device 10A function as a digital key of the vehicle 20. In accordance with a request from the information processing device 10A, the server 30A provides an application of a digital key, information relating to the digital key, and the like to the information processing device 10A as information for functioning as a digital key of the vehicle 20.

The server 30B is a server for providing, to the information processing device 10B, information for having the information processing device 10B function as a digital key of the vehicle 20. In accordance with a request from the information processing device 10B, the server 30B provides an application of a digital key, information relating to the digital key, and the like to the information processing device 10B as information for functioning as a digital key of the vehicle 20.

The servers 30A, 30B can be provided, for example, for each manufacturer of the information processing devices 10A, 10B. If the manufacturers of the information processing devices 10A, 10B are the same, the information for functioning as a digital key may be provided from the same server.

The server 30C is a server that, in cooperation with the servers 30A, 30B, provides the information processing devices 10A, 10B and the vehicle 20 with information for having the information processing devices 10A, 10B function as a digital key of the vehicle 20. The server 30C can be provided for each manufacturer of the vehicle 20. In accordance with a request from the information processing device 10A, 10B or the vehicle 20, or even if there is no request from the information processing devices 10A, 10B or the vehicle 20, the server provides the vehicle 20 with information relating to the digital key, and the like, as information for functioning as a digital key of the vehicle 20.

Note that, although only one information processing device 10B that can become a friend device is illustrated in FIG. 1, in the present disclosure, there may be two or more information processing devices that can become friend devices. Further, in FIG. 1, although only one of each of the servers 30A, 30B, 30C is illustrated, each server may be structured by plural devices.

The vehicle 20 relating to the present embodiment acquires a notification that permission for usage as a key of the vehicle 20 has been granted from the information processing device 10A to the information processing device 10B. Then, in accordance with the acquisition of this notification, the vehicle 20 relating to the present embodiment controls a presentation for urging the information processing device 10B to communicate via an NFC reader provided at the vehicle 20, in order to have the information processing device 10B start usage as a key of the vehicle 20.

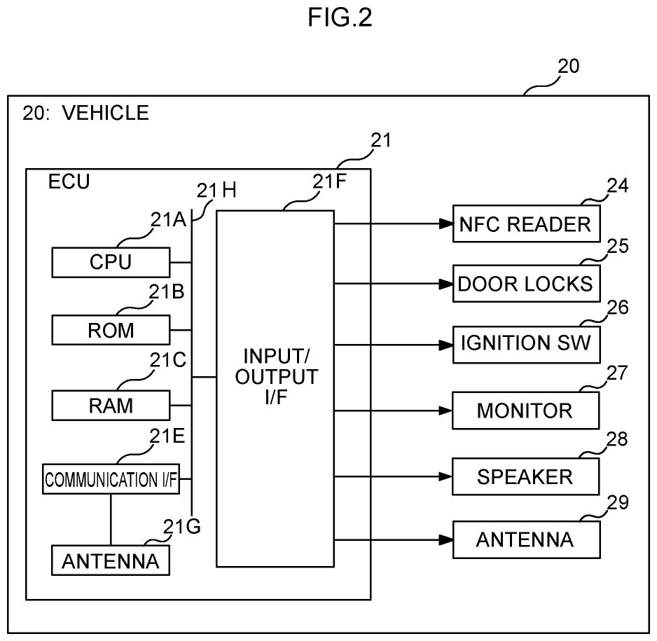

FIG. 2 is a drawing illustrating an example of the hardware structures of the vehicle 20. As illustrated in FIG. 2, the vehicle 20 relating to the present embodiment is structured to include an ECU 21. The vehicle 20 is structured so as to further include an NFC reader 24, door locks 25, an ignition switch (SW) 26, a monitor 27, a speaker 28, and an antenna 29.

The ECU 21 is structured to include a CPU (Central Processing Unit) 21A, a ROM (Read Only Memory) 21B, a RAM (Random Access Memory) 21C, a wireless communication I/F (Interface) 21E, an input/output I/F 21F, and an antenna 21G. The CPU 21A, the ROM 21B, the RAM 21C, the wireless communication I/F 21E and the input/output I/F 21F are connected so as to be able to communicate with one another via internal bus 21H.

The CPU 21A is a central computing processing unit, and executes various programs and controls the respective sections. Namely, the CPU 21A reads-out a program from the ROM 21B, and executes the program by using the RAM 21C as a workspace.

The ROM 21B stores various programs and various data. A control program for controlling the ECU 21 is stored in the ROM 21B of the present embodiment.

The RAM 21C temporarily stores programs and data as a workspace.

The wireless communication I/F 21E is a wireless communication module for communicating with the information processing devices 10A, 10B. Communication standards such as BLE for example are used at this wireless communication module. The wireless communication I/F 21E is connected to the antenna 21G.

The input/output I/F 21F is an interface for communicating with the door locks 25, the ignition SW 26, the monitor 27, the speaker 28 and the antenna 29 that are installed in the vehicle 20.

The antenna 21G is an antenna for transmitting and receiving wireless communication packets by BLE to and from the information processing devices 10A, 10B.

The NFC reader 24 is a reader for carrying out near wireless communication by NFC with devices such as the information processing devices 10A, 10B and the like. The NFC reader 24 can be provided at the center console for example. The NFC reader 24 may have, at the periphery of the reader portion, a light-emitting portion that emits light of a predetermined color or brightness. Light-emitting diodes for example may be used as this light-emitting portion.

The door locks 25 are the locks of the doors of the vehicle 20. In addition to the door locks 25 being opened and closed by a user who is riding in the vehicle 20, the opening and closing of the door locks 25 is controlled by the CPU 21A.

The ignition SW 26 is the switch for starting the engine of the vehicle 20. In addition to the ignition SW 26 being turned on and off by a user who is riding in the vehicle the turning on and off of the ignition SW 26 is controlled by the CPU 21A.

The monitor 27 is provided at the instrument panel, the meter panel or the like, and is a liquid crystal monitor for displaying images relating to the current position, the traveling route, and information to which attention should be paid. A touch panel, which also functions as switches for the input of operations by the fingers of a vehicle occupant, may also be provided at the monitor 27.

The speaker 28 is provided at the instrument panel, the center console, a front pillar, the dashboard or the like, and is a device for outputting sound.

The antenna 29 is an antenna for measuring the radio wave intensities of BLE packets sent by the information processing devices 10A, 10B. The antenna 21G of the ECU 21 is used for wireless transmission with the information processing devices 10, whereas the antenna 29 is used in order to measure the radio wave intensities of BLE packets sent by the information processing devices 10A, 10B. The antenna 29 can be provided at, for example, the front portion, the left side surface portion, the right side surface portion of the vehicle 20. The CPU 21A derives the distance between the information processing device 10 and the vehicle 20 by using the intensity of the radio waves the antenna 29 receives, and judges whether or not the information processing device 10A, 10B is within the cabin of the vehicle 20.

Although FIG. 2 illustrates a structure in which the respective devices of the vehicle 20 are controlled by the one ECU 21, the present disclosure is not limited to this example. For example, the ECU that controls the door locks 25 and the ECU that controls the ignition SW 26 may be different ECUs.

Functional structures that are realized by the vehicle 20 are described next.

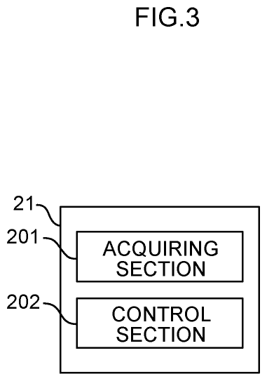

FIG. 3 is a block drawing illustrating an example of the functional structures of the vehicle 20.

As illustrated in FIG. 3, the vehicle 20 has, as the functional structures thereof, an acquiring section 201 and a control section 202. These respective functional structures are realized by the CPU 21A reading-out and executing the control program that is stored in the ROM 21B.

The acquiring section 201 acquires a notification that permission for usage as a key of the vehicle 20 has been granted from the information processing device 10A that is the owner device to the information processing device 10B that is a friend device. This notification is acquired from the server 30C for example.

In accordance with the acquiring section 201 acquiring the above-described notification, the control section 202 controls presentation for urging the information processing device 10B to communicate via the NFC reader 24 provided at the vehicle 20, in order to have the information processing device 10B start usage as a key of the vehicle 20. This having the information processing device 10B start usage as a key of the vehicle 20 is the sharing of information relating to a digital key of the vehicle 20 between the information processing device 10B and the vehicle 20.

As a presentation that urges the information processing device 10B to communicate, the control section 202 may effect control that causes the emission of light at a given place of the NFC reader 24. Due to the NFC reader 24 emitting light, the control section 202 can indicate to the user of the information processing device 10B that the information processing device 10B must be held over the NFC reader 24.

In a case in which the control section 202 carries out control that causes light to be emitted at a given place of the NFC reader 24, the control section 202 may carry out control so as to cause the light to flash. Due to the NFC reader 24 flashing, the control section 202 can indicate to the user of the information processing device 10B that the information processing device 10B must be held over the NFC reader 24.

Or, in a case in which the control section 202 carries out control that causes the NFC reader 24 to emit light at a given place, the control section 202 may carry out control so as to cause the emission of light of a color that is different than the color of the console portion of the vehicle 20. Due to that place of the NFC reader 24 emitting light of a color different than that of the console portion, the control section 202 can indicate to the user of the information processing device 10B that the information processing device 10B must be held over the NFC reader 24.

Still further, in a case in which the control section 202 carries out control that causes light to be emitted at a given place of the NFC reader 24, the control section 202 may carry out control so as to cause light emission at the given place of the NFC reader 24 in accordance with the degree of illumination of the vehicle cabin interior. Due to that place of the NFC reader 24 emitting light in accordance with the degree of illumination of the vehicle cabin interior, the control section 202 can indicate the given place of the NFC reader 24 at a brightness that is suitable for the degree of illumination of the vehicle cabin interior.

As a presentation that urges the information processing device 10B to communicate, the control section 202 may effect control so as to transmit a message to the information processing device 10B that the information processing device 10B is to be held over the NFC reader 24. By transmitting a message to the information processing device 10B, the control section 202 can indicate to the user of the information processing device 10B that the information processing device 10B must be held over the NFC reader 24.

As a presentation for urging the information processing device 10B to communicate via the NFC reader 24, the control section 202 may effect control so as to present a message on the monitor 27. In a case in which the control section 202 carries out control to present a message on the monitor 27, the control section 202 may carry out control so as to present a message in characters, images, or a combination of characters and images. In a case in which the control section 202 carries out control to present a message on the monitor 27, the control section 202 may carry out control so as to, together therewith, also cause a given place of the NFC reader 24 to emit light.

As a presentation for urging the information processing device 10B to communicate via the NFC reader 24, the control section 202 may effect control so as to output sound from the speaker 28. In a case in which the control section 202 carries out control so as to output sound from the speaker 28, the control section 202 may carry out control so as to output a human voice, or may carry out control so as to output a sound effect such as a chime or the like. In a case in which the control section 202 carries out control so as to output sound from the speaker 28, the control section 202 may carry out control so as to, together therewith, also cause a given place of the NFC reader 24 to emit light. In a case in which the control section 202 carries out control so as to output sound from the speaker 28 and cause a given place of the NFC reader 24 to emit light, the timing of the emission of sound and the emission of light may be synchronized.

In a case in which a message is transmitted to the information processing device the control section 202 may transmit the message to the information processing device via the servers 30C, 30B, or may transmit the message to the information processing device 10B via the information processing device 10A.

In a case in which pairing with the information processing device 10B has already been completed by communication that is different than NFC communication via the NFC reader 24, the control section 202 does not have to carry out presentation for urging the information processing device 10B to communicate via the NFC reader 24 provided in the vehicle 20.

If pairing has already been completed, the control section 202 can carry out communication for starting usage of a digital key, by communication via the NFC reader 24 between the vehicle 20 and the information processing device 10B.

Operation of the digital key system of the vehicle 20 is described next.

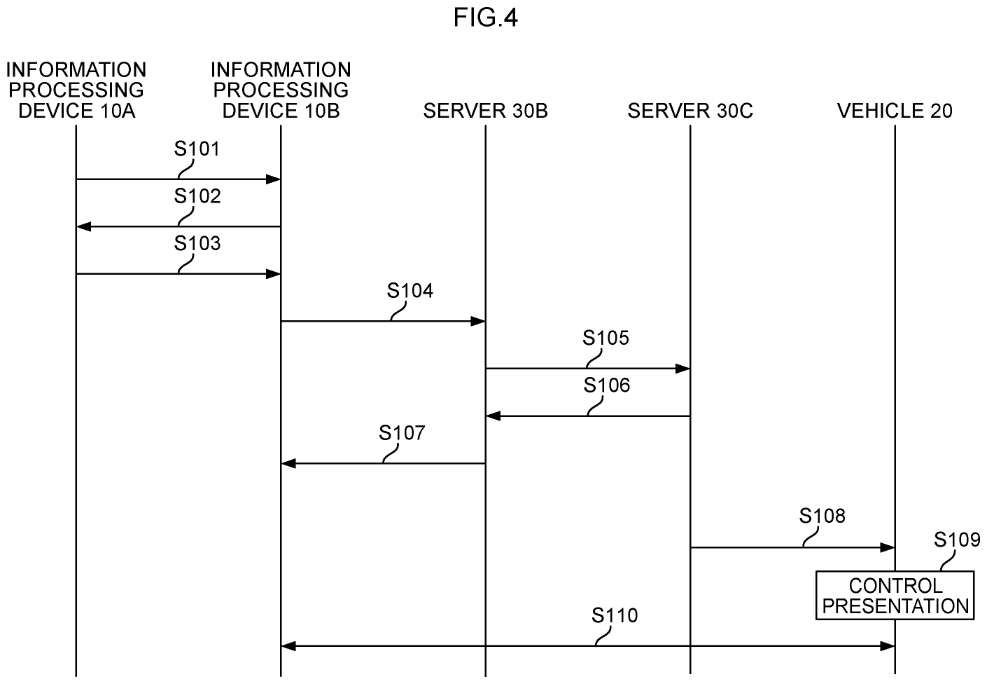

FIG. 4 is a flowchart showing the flow of processing by the digital key system of the vehicle 20. The flowchart illustrated in FIG. 4 is a flowchart at the time of causing the information processing device 10B that is a friend device to start usage of the key of the vehicle 20. Further, in the flowchart illustrated in FIG. 4, as operation of the vehicle 20, the control processing of the vehicle 20 is carried out due to the CPU 21A reading-out the control program stored in the ROM 21B, and expanding and executing the control program in the RAM 21C. Note that the flowchart illustrated in FIG. 4 can be realized due to one or more processors reading and executing programs that are stored in one or more memories.

As preconditions for the processing illustrating in FIG. 4, it is assumed that pairing between the information processing device 10A and the vehicle 20 has been completed, and that a communication channel between the information processing device 10A and the information processing device 10B has been established.

At the time when the information processing device 10B that is a friend device is made to start using a key of the vehicle 20, first, the information processing device 10A that is the owner device asks the information processing device 10B to generate information relating to a digital key of the vehicle 20 (step S101).

In accordance with the request to generate information relating to a digital key of the vehicle 20, the information processing device 10B generates information at the interior, and asks the information processing device 10A to certify the generated information (step S102).

When the information processing device 10A receives the request to certify the information relating to the digital key that was generated by the information processing device 10B, the information processing device 10A generates a certificate for the information generated by the information processing device 10B, and transmits that certificate to the information processing device 10B (step S103).

When the information processing device 10B receives the certificate from the information processing device 10A, the information processing device 10B appends the certificate to the generated information relating to the digital key, and transmits the information to the server 30B (step S104).

The server 30B transmits the information received from the information processing device 10B to the server 30C (step S105).

When the server 30C receives, from the server 30B, the information that was transmitted from the information processing device 10B, the server 30C executes the processing of registering the information, which was transmitted from the information processing device 10B, as a key of the vehicle 20, and returns the results of processing to the server 30B (step S106).

The server 30B transmits the results of processing, which were received from the server 30C, to the information processing device 10B (step S107).

Further, when the server 30C executes the processing of registering the information as a key of the vehicle 20, the server 30C notifies the vehicle 20 that the information processing device 10A has granted the information processing device 10B permission to be used as a key of the vehicle 20 (step S108).

When the CPU 21A of the vehicle 20 acquires the aforementioned notification from the server 30C, the CPU 21A controls a presentation for urging the information processing device 10B to communicate via the NFC reader 24 provided in the vehicle 20 (step S109).

As a presentation that urges the information processing device 10B to communicate via the NFC reader 24, the CPU 21A may effect control that causes the emission of light at a given place of the NFC reader 24. In a case in which the CPU 21A carries out control that causes the NFC reader 24 to emit light at a given place, the CPU 21A may carry out control so as to cause the light to flash. Further, in a case in which the CPU 21A carries out control that causes the NFC reader 24 to emit light at a given place, the CPU 21A may carry out control so as to cause the emission of light of a color that is different than the color of the console portion of the vehicle 20. Still further, in a case in which the CPU 21A carries out control that causes the NFC reader 24 to emit light at a given place, the CPU 21A may carry out control so as to cause the light to be emitted at the given place of the NFC reader 24 in accordance with the degree of illumination of the vehicle cabin interior.

As a presentation that urges the information processing device 10B to communicate via the NFC reader 24, the CPU 21A may effect control so as to transmit a message to the information processing device 10B that the information processing device 10B is to be held over the NFC reader 24. In this case, the CPU 21A may transmit the message to the information processing device 10B via the servers 30C, 30B, or may transmit the message to the information processing device 10B via the information processing device 10A.

As a presentation for urging the information processing device 10B to communicate via the NFC reader 24, the CPU 21A may effect control so as to present a message on the monitor 27. In a case in which the CPU 21A carries out control to present a message on the monitor 27, the CPU 21A may carry out control so as to present a message in characters, images, or a combination of characters and images.

As a presentation for urging the information processing device 10B to communicate via the NFC reader 24, the CPU 21A may effect control so as to output sound from the speaker 28. In a case in which the CPU 21A carries out control so as to output sound from the speaker 28, the CPU 21A may carry out control so as to output a human voice, or may carry out control so as to output a sound effect such as a chime or the like. In a case in which the CPU 21A carries out control so as to output sound from the speaker 28, the CPU 21A may carry out control so as to, together therewith, also cause the NFC reader 24 to emit light at a given place. In a case in which the CPU 21A carries out control so as to output sound from the speaker 28 and cause the NFC reader 24 to emit light at a given place, the timing of the emission of sound and the emission of light may be synchronized.

In a case in which pairing with the information processing device 10B has already been completed by communication that is different than NFC communication via the NFC reader 24, the CPU 21A does not have to carry out presentation for urging the information processing device 10B to communicate via the NFC reader 24 provided in the vehicle 20.

The information processing device 10B carries out near wireless communication with the vehicle 20 via the NFC reader 24, and executes processing for starting usage of the key (step S110).

Due to the vehicle 20 carrying out presentation for urging communication via the NFC reader 24 provided at the vehicle 20, the information processing device 10B that is to become the friend device can be urged to communicate with the vehicle 20.

Note that any of various types of processors other than a CPU may execute the control processing that is executed due to the CPU reading-in software (a program) in the above-described respective embodiments. Examples of processors in this case include PLDs (Programmable Logic Devices) whose circuit structure can be changed after production such as FPGAs (Field-Programmable Gate Arrays) and the like, and dedicated electrical circuits that are processors having circuit structures that are designed for the sole purpose of executing specific processings such as ASICs (Application Specific Integrated Circuits) and the like, and the like. Further, the control processing may be executed by one of these various types of processors, or may be executed by a combination of two or more of the same type or different types of processors (e.g., plural FPGAs, or a combination of a CPU and an FPGA, or the like). Further, the hardware structures of these various types of processors are, more specifically, electrical circuits that combine circuit elements such as semiconductor elements and the like.

Further, the above respective embodiments describe forms in which the control processing program is stored in advance (is installed) in the ROM or the storage, but the present disclosure is not limited to this. The program may be provided in the form of being recorded on a non-transitory recording medium such as a CD-ROM (Compact Disk Read Only Memory), a DVD-ROM (Digital Versatile Disk Read Only Memory), a USB (Universal Serial Bus) memory, or the like. Further, the program may be in the form of being downloaded from an external device over a network.

What is claimed is:

1. A vehicle comprising at least one processor that is configured to:
acquire a notification that permission for usage as a key of the vehicle has been granted from a first information processing device to a second information processing device; and
in accordance with acquisition of the notification, control a presentation for urging the second information processing device to communicate via an NFC (Near Field Communication) reader provided at the vehicle, in order to have the second information processing device start usage as the key.

2. The vehicle of claim 1, wherein, as the presentation for urging communication, the at least one processor causes the NFC reader to emit light at a given place.

3. The vehicle of claim 2, wherein the at least one processor causes the NFC reader to flash light at a time of emitting light at the given place.

4. The vehicle of claim 2, wherein the at least one processor causes the NFC reader to emit light of a different color than a console portion, at a time of emitting light at the given place.

5. The vehicle of claim 2, wherein the at least one processor causes the NFC reader to emit light at the given place in accordance with a degree of illumination of a vehicle cabin interior.

6. The vehicle of claim 1, wherein the at least one processor transmits a message to the second information processing device to hold the second information processing device over the NFC reader.

7. The vehicle of claim 1, wherein the at least one processor does not carry out the presentation in a case in which pairing with the second information processing device by communication, which is different than communication via the NFC reader, has already been completed.

8. A control method for a vehicle in which a processor executes processings of:
acquiring a notification that permission for usage as a key of the vehicle has been granted from a first information processing device to a second information processing device; and
in accordance with acquisition of the notification, controlling a presentation for urging the second information processing device to communicate via an NFC (Near Field Communication) reader provided at the vehicle, in order to have the second information processing device start usage as the key.

9. A non-transitory computer-readable storage medium storing a control program for a vehicle for causing a computer to:
acquire a notification that permission for usage as a key of the vehicle has been granted from a first information processing device to a second information processing device; and
in accordance with acquisition of the notification, control a presentation for urging the second information processing device to communicate via an NFC (Near Field Communication) reader provided at the vehicle, in order to have the second information processing device start usage as the key.
